(19) United States
(12) Patent Application Publication
(10) Pub. No.: US 2024/0346787 A1
(43) Pub. Date: Oct. 17, 2024

(54) METHOD FOR USER IMAGE DATA MATCHING IN METAVERSE-BASED OFFICE ENVIRONMENT, STORAGE MEDIUM IN WHICH PROGRAM FOR EXECUTING SAME IS RECORDED, AND USER IMAGE DATA MATCHING SYSTEM INCLUDING STORAGE MEDIUM

(71) Applicant: ZIGBANG CO., LTD., Seoul (KR)

(72) Inventors: Dae Wook KIM, Anyang-si (KR); Dae Ho KIM, Seongnam-si (KR); Sung Chul JE, Siheung-si (KR); Do Haeng LEE, Yongin-si (KR); Yong Jae CHOI, Seongnam-si (KR)

(73) Assignee: ZIGBANG CO., LTD., Seoul (KR)

(21) Appl. No.: 18/756,444

(22) Filed: Jun. 27, 2024

Related U.S. Application Data
(63) Continuation of application No. PCT/KR2022/018817, filed on Nov. 25, 2022.

(30) Foreign Application Priority Data
Dec. 28, 2021 (KR) 10-2021-0189840

(51) Int. Cl. G06T 19/00; G06T 7/73

(52) U.S. Cl. CPC G06T 19/006; G06T 7/73; G06T 2207/30196; G06T 2219/024

(57) ABSTRACT

The present invention relates to a method for user image data matching in a metaverse-based office environment and, more particularly, to a method for user image data matching in a metaverse-based office environment, the method comprising: a chat group identification step of identifying a camera viewpoint of a target user in a virtual space, and identifying whether a chat group for users included in a virtual image of the camera viewpoint is included; and a user image matching step of matching user images to avatars of respective group users included in the chat group, the user images being obtained by image-capturing the group users in real time.

### CROSS-REFERENCE TO RELATED PATENT APPLICATION

This application is a continuation of International Application, PCT/KR2022/018817, filed on Nov. 25, 2022, which claims the benefit of Korean Patent Application No. 10-2021-0189840, filed on Dec. 28, 2021, in the Korean Intellectual Property Office, the disclosure of which is incorporated herein in its entirety by reference.

### TECHNICAL FIELD

The present disclosure relates to a user image data matching method in a metaverse-based office environment and, more particularly, to a method in which, in building an office environment in a 3D virtual space based on metaverse, the current situation of the participant (user) corresponding to a character (avatar) connected to the office environment is filmed in real time and overlapped with a virtual image to thereby greatly improve social ties in the virtual space pursued by the metaverse.

In particular, the present disclosure relates to a user image data matching method in a metaverse-based office environment in which image data of a video camera captured at a remote location is received and placed as a two-dimensional shape at the head position of the character in a three-dimensional virtual space so as to replace the character's face with user image data captured in real time, which allows additional information such as the other person's facial expressions or actions to be conveyed at the same time without being limited simply to conversations through text.

### BACKGROUND ART

The term “metaverse” is a compound word of “meta”, meaning virtual or beyond, and “universe”, meaning world or space, and refers to a three-dimensional virtual world where social activities similar to the real world take place.

Metaverse is a concept that is one step further evolved than virtual reality (VR, a cutting-edge technology that allows people to have a realistic experience in a virtual world created on computers), and has the characteristic of using avatars to not only enjoy games or virtual reality, but also to engage in social and cultural activities among members (avatars) like in real life.

Meanwhile, virtual reality refers to a human-computer interface that creates a specific environment or situation with a computer so as to make it as if the person using it is interacting with the actual surrounding situation or environment.

This virtual reality is mainly intended to allow people to show and manipulate environments that are difficult to experience on a daily basis as if they were in the environment without directly experiencing it, and its application areas include games, education, advanced programming, remote manipulation, remote satellite surface exploration, exploration data analysis, and scientific visualization.

As a result, metaverse can be seen as creating a specific environment or situation using a computer and allowing social ties between users to be more active within this environment or situation.

Recently, as working from home has become more active due to various reasons such as IT infrastructure and social development, and health crisis, methods of performing work in this metaverse-based virtual office environment are being developed.

As a related art document, Korean Patent Laid-open Gazette No. 10-2019-0062045 entitled “Method and Apparatus for Virtual Meeting Implementation” (hereinafter referred to as “related art technique”) is intended to implement a virtual meeting space with increased realism by displaying a part of the user's body in an overlapping manner on the image of the virtual meeting in progress. However, in the related art technique, since the user's image being overlapped is a still photo-like image, it may be difficult to state that improved information (information such as facial expressions or actions) beyond text is conveyed during the user's conversation.

Generally, a conversation, which is one of the most important aspects of communication between members (people) in the real world, may deliver information with a more accurate meaning by identifying visual information such as facial expressions, intonation, and gestures in addition to the voice information of the conversation itself.

As a result, in text conversations such as chat, the sentence itself may cause misunderstanding, so various emoticons may be used together to converse, but these emoticons alone may have limitations in conveying the exact meaning or feeling.

In other words, the related art technique remains at the level of simple online communication through text, and has a problem of failing to improve the bond between members like in the real world.

Further, the related art technique simply overlaps the images of users with an office image as the background on a computer and is not based on a virtual space, so it is difficult to state that this technology field is based on virtual reality.

### DISCLOSURE

### Technical Problem

In order to solve the above-described problem, an object of the present disclosure is to provide a user image data matching method in a metaverse-based office environment in which, in building an office environment in a 3D virtual space based on metaverse, the current situation of the participant (user) corresponding to a character (avatar) connected to the office environment is filmed in real time and overlapped with a virtual image to thereby greatly improve social ties in the virtual space pursued by the metaverse.

In particular, the present disclosure relates to a user image data matching method in a metaverse-based office environment in which image data of a video camera captured at a remote location is received and placed as a two-dimensional shape at the head position of the character in a three-dimensional virtual space so as to replace the character's face with user image data captured in real time, which allows additional information such as the other person's facial expressions or actions to be conveyed at the same time without being limited simply to conversations through text.

In addition, an object of the present disclosure is to provide a user image data matching method in a metaverse-based office environment that may form a chat group satisfying specific conditions among users connected to the virtual space and allow conversation only within the chat group, preventing problems such as information leakage from occurring in the process of transmitting information in advance.

### Technical Solution

To achieve the above object, a method for matching user image data in a metaverse-based office environment according to the present disclosure includes: a chat group identification step of identifying a camera viewpoint of a target user in a virtual space and checking whether users included in a virtual image of the camera viewpoint are included in a chat group; and a user image matching step of matching, for each group user included in the chat group, a user image of the group user captured in real time to an avatar of the group user.

In addition, the user image matching step may match the user image to the head of the avatar.

In addition, the user image matching step may include: a target coordinate identification step of identifying two-dimensional coordinates to which the head position of the corresponding avatar is projected in the virtual image of a camera coordinate system to which the virtual space of a three-dimensional coordinate system is projected; and a user image overlap step of overlapping the corresponding user image with the two-dimensional coordinates of the virtual image.

In addition, the target coordinate identification step may include: an avatar position identification step of identifying a position of the corresponding avatar in the three-dimensional virtual space; a relative position identification step of calculating a relative position of the head in a skeletal structure of the corresponding avatar; a head position identification step of calculating three-dimensional coordinates of the head by applying the relative position to three-dimensional coordinates of the corresponding avatar; and a projection coordinate identification step of identifying two-dimensional coordinates to which the head position of the corresponding avatar is projected.

In addition, the method may further include an avatar configuration information identification step of identifying configuration information of an avatar matched to the corresponding group user, before the target coordinate identification step.

In addition, the user image matching step may perform image processing on the user image to extract the head of the corresponding user and match the extracted image to the head of the corresponding avatar.

In addition, the user image matching step may extract a specific image region of the head of the user with a preset feature point as the center.

In addition, the user image matching step may overlap, after an initial image region is extracted based on the feature point, an image region extracted thereafter regardless of movement of the corresponding user in a fixed way.

In addition, the chat group identification step may include: a spatial zone identification step of identifying spatial zones divided by settings in the virtual space; and a chat group determination step of determining a user located in the same spatial zone as the target user as belonging to the chat group.

In addition, the chat group determination step may place a chat group participation restriction on at least some spatial zones including a security area in the virtual space and exclude those users whose chat participation rights have been removed among users located in the corresponding spatial zone from the corresponding chat group.

In addition, the present disclosure includes a storage medium on which a program for executing the user image data matching method in the metaverse-based office environment is recorded.

In addition, the present disclosure includes a user image data matching system including the above storage medium in a metaverse-based office environment.

### Advantageous Effects

Through the above solutions, the present disclosure has the advantage of greatly improving social ties in the virtual space pursued by metaverse by filming, in building an office environment in a 3D virtual space based on metaverse, the current situation of the participant (user) corresponding to a character (avatar) connected to the office environment in real time, and overlapping it with a virtual image.

In particular, the present disclosure has the advantage of conveying additional information such as the other person's facial expressions or actions at the same time without being limited simply to conversations through text by receiving image data of a video camera captured at a remote location and placing it as a two-dimensional shape at the head position of the character in a three-dimensional virtual space so as to replace the character's face with user image data captured in real time.

Thereby, the present disclosure has the advantage of conveying information with a more accurate meaning by identifying visual information such as facial expressions, intonation, and gestures of users in addition to the voice information of the conversation itself.

As a result, the present disclosure allows individual members (users) to connect online but may provide the same level of conversation as if they were talking face-to-face in the real world, thereby greatly enhancing the bond between members.

In addition, the present disclosure has the advantage of preventing problems such as information leakage from occurring in the process of transmitting information in advance by forming a chat group satisfying specific conditions among users connected to the virtual space and allowing conversation only within that chat group.

In particular, even in the real world, there are cases where other people hear the content of the conversation, causing information to be leaked and spread, and in severe cases, rumors or the like may be created, but the present disclosure may fundamentally prevent such problems.

### DESCRIPTION OF DRAWINGS

FIG. 1 is a flow diagram illustrating an embodiment of a user image data matching method in a metaverse-based office environment according to the present disclosure.

FIG. 2 is a flow diagram illustrating a specific embodiment of step S200 in FIG. 1.

FIG. 3 is a flow diagram illustrating a specific embodiment of step S210 in FIG. 2.

FIG. 4 is a flow diagram illustrating another embodiment of FIG. 2.

FIG. 5 is a flowchart illustrating a specific embodiment of FIG. 1.

FIG. 6 is a flow diagram illustrating a specific embodiment of step S100 in FIG. 1.

FIG. 7 is a diagram showing an example of a virtual image to which a user image is matched according to FIG. 1.

### MODE FOR DISCLOSURE

Examples of a user image data matching method in a metaverse-based office environment according to the present disclosure may be applied in various ways, and the most preferred embodiment will be described below with reference to the attached drawings.

First, the user image data matching method in a metaverse-based office environment of the present disclosure may be executed in a server/client system on the Internet, and the configuration for executing the method may be a stationary computing device such as desktop, workstation, or server, or may be a portable computing device such as smartphone, laptop, tablet, phablet, portable multimedia player (PMP), personal digital assistant (PDA), or e-book reader.

Additionally, the user image data matching method in a metaverse-based office environment of the present disclosure may be executed in at least one configuration of a server or a client in a server/client system, and with at least two cooperating configurations, the process corresponding to the method may be divided and executed in a distributed manner according to an operational scheme. At this time, the client may include an administrator's terminal excluding the server as well as a user terminal used by the user.

In addition, technical terms used in the process of describing the present disclosure, unless specifically defined in a different way, should be interpreted as meanings generally understood by those skilled in the art to which the present disclosure pertains, and they should not be interpreted in a too comprehensive sense or in an excessively narrow sense.

In addition, if the technical term used to describe the present disclosure is an incorrect technical term that does not accurately express the idea of the present disclosure, it should be understood as being replaced with a technical term that can be correctly understood by a person skilled in the art.

In addition, general terms used in the present disclosure should be interpreted according to the definition in the dictionary or according to the context, and should not be interpreted in an excessively narrow sense.

In addition, singular expressions used to describe the present disclosure may include plural expressions, unless the context clearly indicates otherwise.

In addition, terms such as “include” or “have” should not be construed as necessarily including multiple components or multiple steps, and should be interpreted that some of the components or steps may be not included or additional components or steps may be added.

In addition, the terms “1^{st}” and “2^{nd}” or “first” and “second” may be used to distinguish one element from another element, without limiting corresponding elements in another aspect such as importance or order.

For example, a first component may be denoted as a second component, and vice versa, without departing from the scope of the present disclosure.

In addition, when a first element is referred to as being “coupled to” or “connected to” a second element, it may be coupled or connected to the second element directly or via a third element.

In contrast, it will be understood that when a first element is referred to as being “directly coupled to” or “directly connected to” a second element, no other element intervenes between the first element and the second element.

Hereinafter, when describing the present disclosure with reference to the attached drawings, identical or similar components will be assigned the same reference numbers throughout the drawings, and repeated descriptions thereof will be omitted.

In addition, when describing the present disclosure, related well-known functions or constructions may be not described in detail since they would obscure the gist of the present disclosure through unnecessary detail.

In addition, the attached drawings are only intended to facilitate easy understanding of the spirit of the present disclosure and should not be construed as limiting the spirit of the present disclosure, and the spirit of the present disclosure should be construed as extending to all changes, equivalents, or substitutes in addition to the attached drawings.

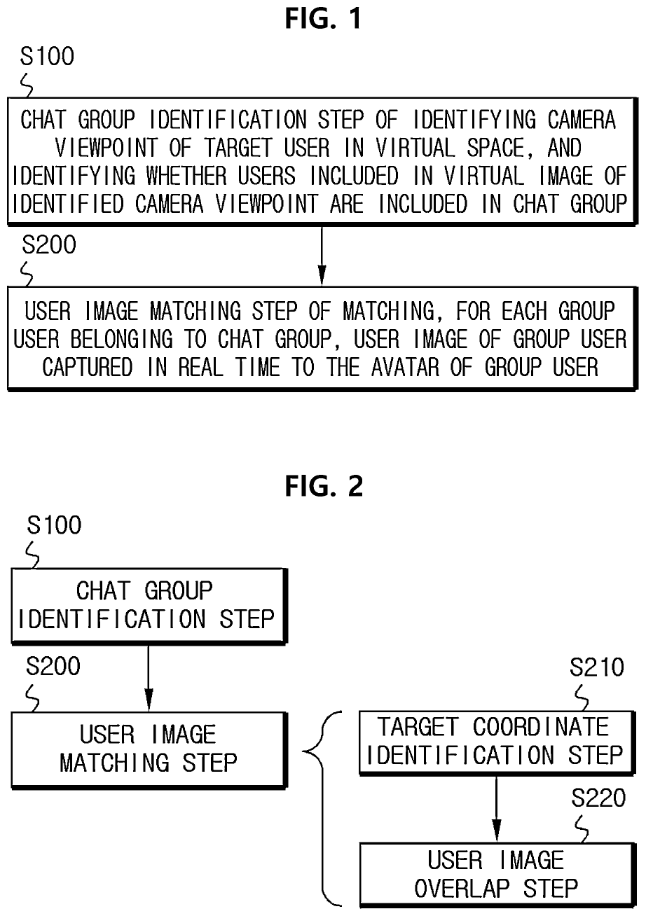

FIG. 1 is a flow diagram illustrating an embodiment of a user image data matching method in a metaverse-based office environment according to the present disclosure.

With reference to FIG. 1, the user image data matching method in a metaverse-based office environment includes a chat group identification step (S100) and a user image matching step (S200).

The chat group identification step (S100) is a process of identifying users (group users) who may converse with the target user (self-user) in a metaverse-based office environment, where the camera viewpoint of the target user is identified in the virtual space, and whether users included in the virtual image of the identified camera viewpoint are included in a chat group is identified.

Here, the camera viewpoint may be based on the target user's avatar or the rear upper part of the target user's avatar, the virtual space may be formed based on a three-dimensional coordinate system, and the virtual image is an image output to the user's terminal as shown in FIG. 7 with respect to the camera viewpoint and refers to an image in which the three-dimensional coordinates of the virtual space are projected to two dimensions.

As a result, the chat group identification step (S 100) is a process of identifying at least some users to be included in the chat group according to specific conditions among the avatars displayed on the target user's terminal.

The user image matching step (S200) is a process of matching, for each group user belonging to the chat group, a user image of the group user captured in real time to the avatar of the group user; more specifically, as shown in FIG. 7, for a specific user, a user image may be matched to the head of the corresponding avatar.

This will be described in more detail below.

FIG. 2 is a flow diagram illustrating a specific embodiment of step S200 in FIG. 1.

With reference to FIG. 2, the user image matching step (S200) includes a target coordinate identification step (S210) and a user image overlap step (S220).

The target coordinate identification step (S210) is a process of identifying the two-dimensional coordinates where the head position of the corresponding avatar is projected in a virtual image of the camera coordinate system, where the virtual space of the three-dimensional coordinate system in which the metaverse-based office environment is built is projected to the display of the user terminal used by the user.

For example, as shown in FIG. 7, when a user image of the user is overlapped with the head of the corresponding avatar, the target coordinate identification step (S210) calculates two-dimensional coordinates by converting the three-dimensional coordinates corresponding to the head of the avatar located in the three-dimensional virtual space into the two-dimensional coordinate system of the virtual image being a projected planar image.

Thereafter, in the user image overlap step (S220), the user image is overlapped with the corresponding two-dimensional coordinates of the virtual image.

For example, in case of matching a user image to the head of a corresponding avatar in the virtual space and then displaying it, a lot of calculations would be required to adjust the size of the user image or the like according to the movement of the avatar. However, as in the present disclosure, when three-dimensional coordinates are converted to two-dimensional coordinates and then the user image is matched to the two-dimensional coordinates, since only coordinate transformation needs to be calculated in the process, the amount of data calculation may be greatly reduced, and through this, online real-time processing can be made easier.

Next, a more detailed description will be given of the process of converting three-dimensional coordinates to two-dimensional coordinates.

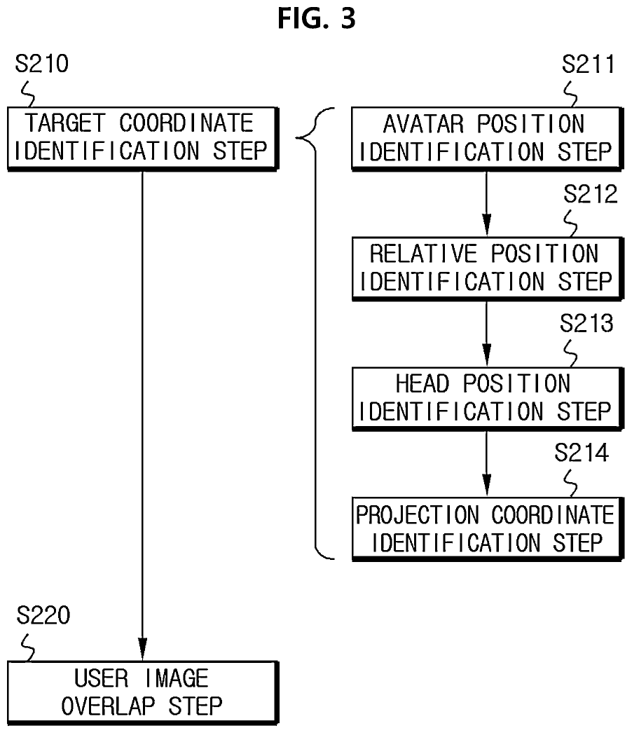

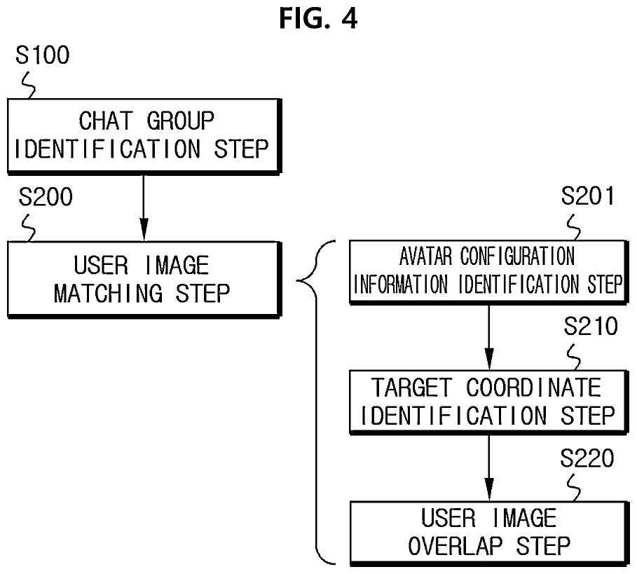

FIG. 3 is a flow diagram illustrating a specific embodiment of step S210 in FIG. 2. FIG. 4 is a flow diagram illustrating another embodiment of FIG. 2.

First, when a target user connects to the metaverse-based office environment, the location of the avatar matched to the target user may be identified in the three-dimensional virtual space (S211).

Here, the initial location of the avatar upon login may be the location at the time of previous logout, or may include a preset fixed location (e.g., front door of virtual office, etc.).

Then, from the skeleton structure of the avatar, the reference position of the avatar and the relative position of the head are calculated (S212), and the three-dimensional coordinates of the head may be calculated by applying the relative position to the three-dimensional coordinates of the avatar (S213).

Meanwhile, the avatar may be configured in various forms by the target user.

Therefore, in the present disclosure, as shown in FIG. 4, before the target coordinate identification step (S210), an avatar configuration information identification step (S201) may be performed to identify the configuration information for the avatar of a group user identified in the chat group identification step (S100).

In other words, for a group user identified as belonging to the chat group in the chat group identification step (S100), the external characteristics (skeleton) of the corresponding avatar may be identified by checking the configuration information of the group user (S201), and based on this, the relative position of the avatar's head may be calculated (S212).

Thereafter, the three-dimensional coordinates of the head position of the avatar may be identified (S213), and the two-dimensional coordinates on which the head position of the avatar is projected is identified to determine the head (target) position of the avatar to be displayed in the virtual image (S214).

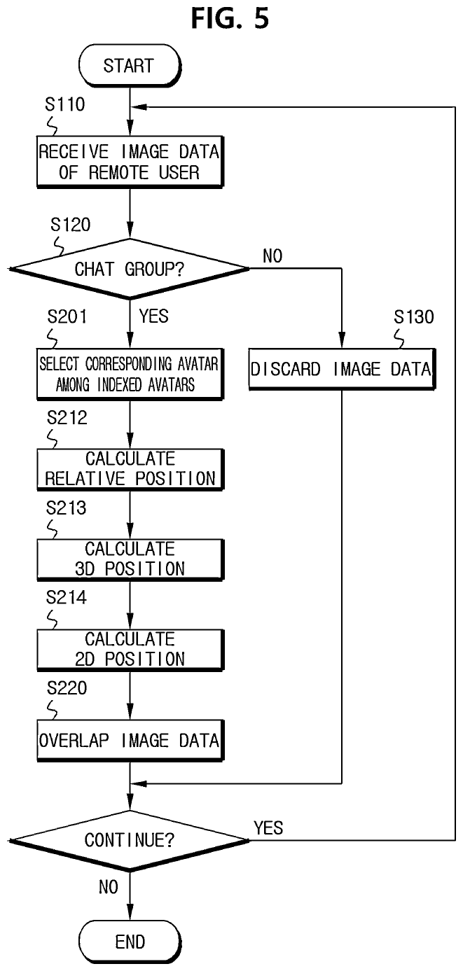

FIG. 5 is a flowchart illustrating a specific embodiment of FIG. 1.

First, while the avatar of the target user moves, for each of multiple users (remote users) included in the camera viewpoint of the avatar, image data (user image) of the user may be received (S110). At this time, the image data may be matched to the ID of the corresponding user.

Thereafter, whether the user belongs to the chat group conversing with the target user (me) may be determined (S120), and if not belonging to the chat group, the corresponding image data may be discarded (S130).

If the user belongs to the target user's chat group (S120), the avatar matched (indexed) to the ID of the user may be selected (S201), the relative position and three-dimensional position of the target (head) may be calculated as described previously (S212, S213), based on this, the two-dimensional position of the virtual image to be projected may be calculated (S214), and the received image data may be overlapped at the corresponding position (S220).

In other words, in FIG. 5, for users located in a specific space (or included in the camera viewpoint) in a metaverse-based office environment, the image data of each user may be received; if the user is in the chat group, the corresponding image data may be overlapped, and if the user is not in the chat group, the corresponding image data may be discarded.

Of course, as described above, belonging to the chat group may be checked first, and then user images of the users belonging to the chat group may be received and overlapped with the corresponding avatars.

These methods can be performed by selecting and applying the optimal method according to the building information (size, resolution, complexity, etc.) of the office environment, data processing methods, and the needs of those skilled in the art.

Additionally, in the process of matching the user image to the avatar's head, when a user image obtained by capturing a remote user is received, the user image may be image-processed to extract the necessary part with the head of the user as the center as shown in FIG. 7, and the extracted image may be matched to the head of the avatar. In other words, by removing unnecessary images such as background, the amount of data of transmitted images may be minimized.

Here, when extracting an image corresponding to the user's head, it is possible to extract a specific image region with a preset feature point (e.g., eyes, nose, etc.) as the center. When image extraction is performed based on a feature point in this way, the amount of data calculations during image processing may be greatly reduced compared to a method of image extraction based on the face boundary.

In this way, when an initial image region is extracted based on the feature points, thereafter the image region extracted regardless of movement of the corresponding user may be fixedly overlapped, so not only changes in the user's facial expression but also actions (head movement, etc.) may be easily identified, which enables more accurate conveyance of meaning in a conversation.

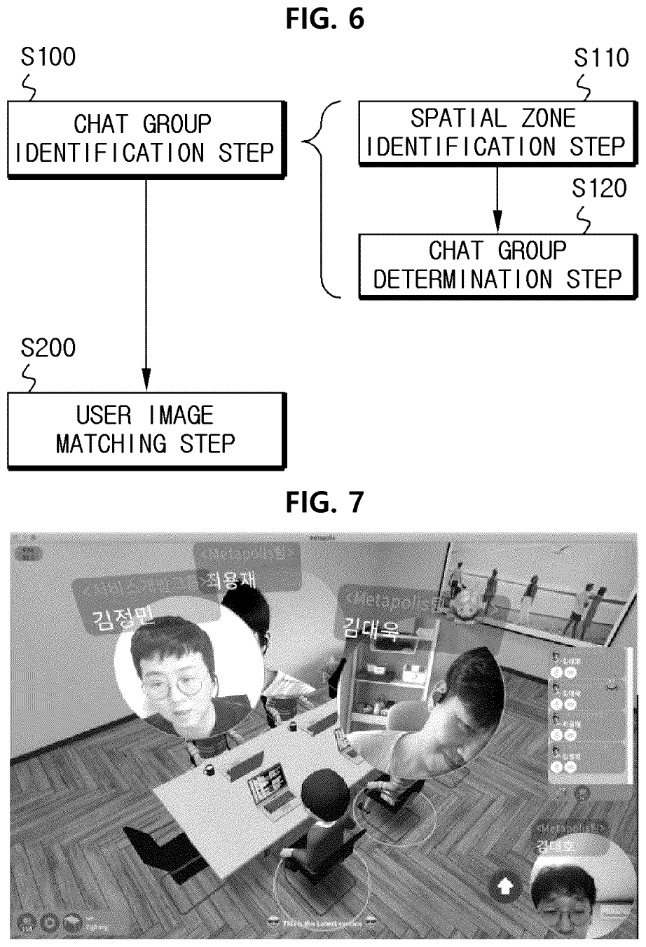

FIG. 6 is a flow diagram illustrating a specific embodiment of step S100 in FIG. 1.

With reference to FIG. 6, the chat group confirmation step (S100) may include a spatial zone identification step (S110) and a chat group determination step (S120).

First, in the spatial zone identification step (S110), the spatial zones divided by settings may be identified in the virtual space. For example, spatial zones divided by usage (meeting room, hallway, break room, etc.) may be identified in a virtual office space. As another example, the space of a virtual office may be divided into a zone included in the camera viewpoint and a zone not included therein.

If the space where the target user is located is divided and identified in this way, in the chat group determination step (S120), the users located in the same spatial zone as the target user may be determined as belonging to the chat group.

Meanwhile, in accordance with the purpose of the present disclosure for constructing a metaverse-based office environment similar to the real world, one building created in the virtual space may be used by one company, or may be jointly used by many companies or individuals in some cases.

To this end, in the present disclosure, when forming a chat group, the right to form a chat group (chat participation right) may be basically granted to all users belonging to the corresponding space as a whole (entire building), and these users may be allowed to join or leave the chat group by using the method described above.

However, in a zone set as a security area for a specific company or individual, the chat participation right may be granted only to users allowed to use the security zone, so that even if a user not having a chat participation right is located in the corresponding space, the user may be not allowed to participate in a conversation in the corresponding security zone.

For example, in the case of a conference room of a specific company, by granting the chat participation right only to users who are employees of the company or are business partners, it is possible to prevent the content of conversations from being leaked to other users unrelated to work, thereby improving security.

In the case of a public space (e.g., break room, hallway, etc.), the conversation participation right may be granted so that all users can participate in conversations, just like in the real world.

In other words, after all users are basically given the chat participation right for all spaces, in the case of a zone set as a security area, a chat group participation restriction may be placed to remove the conversation participation rights of users not matched with a specific team or affiliation, so that only users on the team matched with the target user may be allowed to participate in the conversation.

The user image data matching method in a metaverse-based virtual office environment described above may be implemented as computer-readable code on a computer-readable recording medium.

Here, computer-readable recording media include all types of recording devices that store data that can be read by a computer system. For example, computer-readable recording media may include ROM, RAM, CD-ROM, magnetic tape, floppy disk, optical data storage, etc.

In addition, computer-readable recording media may be distributed in computer systems connected over a network, so that the computer-readable code can be stored and executed in a distributed manner.

In addition, the functional programs, codes, and code segments for implementing the present disclosure may be easily deduced by programmers in the art to which the present disclosure belongs.

In addition, a person skilled in the art will understand that the technical configuration of the present disclosure can be implemented in various specific forms without changing the technical idea or essential features of the present disclosure.

Therefore, the embodiments described hereinabove should be understood as being illustrative in all respects and as not being limited.

### INDUSTRIAL APPLICABILITY

The present disclosure can be used not only in the metaverse field, virtual reality field, and virtual office field, but also in similar or related fields, and can improve reliability and competitiveness in the corresponding field.

1. A method for matching user image data in a metaverse-based office environment, the method comprising:
a chat group identification step of identifying a camera viewpoint of a target user in a virtual space and checking whether users included in a virtual image of the camera viewpoint are included in a chat group; and
a user image matching step of matching, for each group user included in the chat group, a user image of the group user captured in real time to an avatar of the group user.

2. The method of claim 1, wherein the user image matching step matches the user image to the head of the avatar.

3. The method of claim 2, wherein the user image matching step comprises:
a target coordinate identification step of identifying two-dimensional coordinates to which the head position of the corresponding avatar is projected in the virtual image of a camera coordinate system to which the virtual space of a three-dimensional coordinate system is projected; and
a user image overlap step of overlapping the corresponding user image with the two-dimensional coordinates of the virtual image.

4. The method of claim 3, wherein the target coordinate identification step comprises:
an avatar position identification step of identifying a position of the corresponding avatar in the three-dimensional virtual space;
a relative position identification step of calculating a relative position of the head in a skeletal structure of the corresponding avatar;
a head position identification step of calculating three-dimensional coordinates of the head by applying the relative position to three-dimensional coordinates of the corresponding avatar; and
a projection coordinate identification step of identifying two-dimensional coordinates to which the head position of the corresponding avatar is projected.

5. The method of claim 4, further comprising an avatar configuration information identification step of identifying configuration information of an avatar matched to the corresponding group user, before the target coordinate identification step.

6. The method of claim 2, wherein the user image matching step performs image processing on the user image to extract the head of the corresponding user and matches the extracted image to the head of the corresponding avatar.

7. The method of claim 6, wherein the user image matching step extracts a specific image region of the head of the user with a preset feature point as the center.

8. The method of claim 7, wherein the user image matching step overlaps, after an initial image region is extracted based on the feature point, an image region extracted thereafter regardless of movement of the corresponding user in a fixed way.

9. The method of claim 1, wherein the chat group identification step comprises:
a spatial zone identification step of identifying spatial zones divided by settings in the virtual space; and
a chat group determination step of determining a user located in the same spatial zone as the target user as belonging to the chat group.

10. The method of claim 9, wherein the chat group determination step places a chat group participation restriction on at least some spatial zones including a security area in the virtual space and excludes those users whose chat participation rights have been removed among users located in the corresponding spatial zone from the corresponding chat group.

11. A storage medium in which a program for executing the method for matching user image data in a metaverse-based office environment as described in claim 1 is recorded.

12. A system for matching user image data in a metaverse-based office environment, including the storage medium of claim 11.
